(19) United States
(12) Patent Application Publication
(10) Pub. No.: US 2003/0136429 A1
(43) Pub. Date: Jul. 24, 2003

(54) Vapor cleaning and liquid rinsing process vessel

(75) Inventors: Dana Scranton, Kalispell, MT (US); Eric J. Bergman, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/055,467

(22) Filed: Jan. 22, 2002

(51) Int. Cl. B08B 3/10

(52) U.S. Cl. 134/30; 134/35; 134/36; 134/102.1; 134/95.2; 134/105; 134/902

(57) ABSTRACT

A processor for cleaning, rinsing, and drying workpieces includes a process vessel, an ozone injection system for introducing ozone gas into the process vessel, a liquid injection system for introducing a processing fluid into the process vessel, and a drying system for delivering a drying fluid to the process vessel. The processing fluid is introduced into the process vessel such that the processing fluid lies beneath a workpiece. Ozone gas is introduced into the process vessel. The workpiece is then bathed in the processing fluid. A drying fluid is introduced into the process vessel while the processing fluid is evacuated from the process vessel. Microelectronic workpieces can be cleaned and dried in a single vessel, reducing the equipment and space used in manufacturing.

### FIELD OF THE INVENTION

The field of the invention is cleaning, rinsing, and drying a microelectronic workpiece. More specifically, the field of the invention relates to methods and devices that use vapor-phase processes to clean contaminants from the surface of a microelectronic workpiece, and liquid-phase treatment to rinse and the workpiece. A microelectronic workpiece is defined here to include a workpiece formed from a substrate on which microelectronic circuits or components, data storage elements or layers, or micro-mechanical or optical elements are formed.

### BACKGROUND OF THE INVENTION

During the processing of microelectronic workpieces into e.g., electronic devices such as integrated circuits, it is necessary to clean, rinse, and dry the workpieces. The cleaning process can involve the stripping of photoresist or contaminants that remain on the surface of the workpiece. In some cleaning processes, a vapor-phase is used to clean the workpiece. The vapor-phase typically includes ozone, O₃, which is introduced into a process vessel or chamber. The O₃ can be injected into the process vessel as a dry gas, or alternatively, the O₃ can be bubbled through water to produce a moist vapor. The O₃ that is introduced into the process vessel chemically reacts with photoresist and contaminants on the surface of the workpiece.

The cleaning process removes, to the greatest extent possible, residual chemicals such as photoresist, particulate matter, organic species and contaminants that adhere to the surface of the workpiece. Chemical residue and contaminants that are not removed during the cleaning and drying steps reduce the overall yield of the manufacturing process. This reduces the number of usable electronic components, such as integrated circuits, microprocessors, memory devices, etc. that can be obtained from a workpiece.

To reduce the contamination, various surface tension effect cleaning and drying techniques have been used. Two of the most widely used technologies include thermocapillary and solutocapillary techniques. An example of a thermocapillary technique is disclosed in U.S. Pat. No. 4,722,752 (Steck). Steck teaches that the use of warm or hot water, with the subsequent reduction in surface tension, can aid in the drying of a semiconductor wafer through a combination of evaporation and low surface tension.

U.S. Pat. Nos. 4,911,761 (McConnell et al.), 5,271,774 (Leenaars et al.), 5,807,439 (Akatsu et al.), 5,571,337 (Mohindra et al.), and European Patent Specification No. 0 385 536 B1 (Lenarrs et al.) describe solutocapillary techniques.

These solutocapillary techniques typically clean and dry semiconductor wafers by introducing an organic solvent such as isopropyl alcohol (IPA) on the surface of a liquid such as deionized water. In some applications, the layer of solvent is then allowed to recede over the semiconductor wafers. In other applications, the semiconductor wafers are lifted out of the water bath. In either case, the organic solvent creates a displacement of the water on the liquid surface, effectively diluting the water near the surface. This reduces the surface tension of the surface region, causing displacement of water on the wafer surface by the organic solvent. The reduced surface tension located adjacent to the face of the semiconductor wafer promotes the removal of water and contaminants from the work piece.

Currently, vapor-phase cleaning process and the liquid-phase rinsing and drying processes are carried out in separate processing vessels. Workpieces are cleaned with the vapor-phase process in a first vessel or chamber. They are transferred to a second vessel for completion with the rinsing and drying steps. Since the cleaning and rinsing processes are performed in two separate pieces of equipment, more floor space is required for the overall process. It is desirable, however, to reduce the overall floor space needed to process microelectronic workpieces, due to the high cost required to house, maintain, and operate a semiconductor manufacturing facility under extremely clean conditions.

Accordingly, there is a need for an apparatus and method that combines the vapor-phase cleaning process with the liquid-phase rinsing and drying process into a single process vessel, to reduce the floor space and equipment required to process semiconductor wafers, or microelectronic workpieces in general.

### SUMMARY OF THE INVENTION

In a first aspect of the invention, a processor for cleaning, rinsing, and drying a microelectronic workpiece includes a process vessel, an ozone or reactive gas or vapor supply system, a liquid injection system, and a drying system. The process vessel holds one or more workpieces. The ozone supply system introduces ozone gas into the process vessel. The liquid supply system introduces a processing liquid into the process vessel. The drying system provides a drying gas, vapor, or liquid.

In a second aspect of the invention, the processor according to the first aspect includes a gas bubbler for introducing ozone gas into the process vessel.

In a third aspect of the invention, a method for cleaning, rinsing, and drying a microelectronic workpiece inside a single process vessel includes the steps of first introducing a processing fluid into the process vessel with the processing fluid lying beneath the workpiece. Ozone gas is then preferably introduced into the process vessel. The workpiece is then immersed in the processing fluid. The processing fluid is removed from the process vessel and a drying fluid is then introduced into the process vessel. Use of a single vessel reduces floor space and handling requirements, and can expedite processing.

It is an object of the invention to provide an improved method and apparatus for cleaning, rinsing, and drying of a microelectronic workpiece. It is a further object of the invention to provide an improved method and apparatus that combines a vapor-phase cleaning process with a liquid-phase rinsing and drying process in a single processor or equipment.

The invention resides as well in subcombinations of the features and steps described. While use of ozone is preferred, it is not essential to the invention. Rather, the invention more broadly contemplates performing vapor phase process and then an immersion process and a drying process, in a single vessel regardless of the fluid chemicals used. A fluid here can be a liquid, a gas, or a vapor.

### BRIEF DESCRIPTION OF THE DRAWING

FIG. 1 is a cut away perspective view of the cleaner/rinser/dryer system or processor.

### DETAILED DESCRIPTION

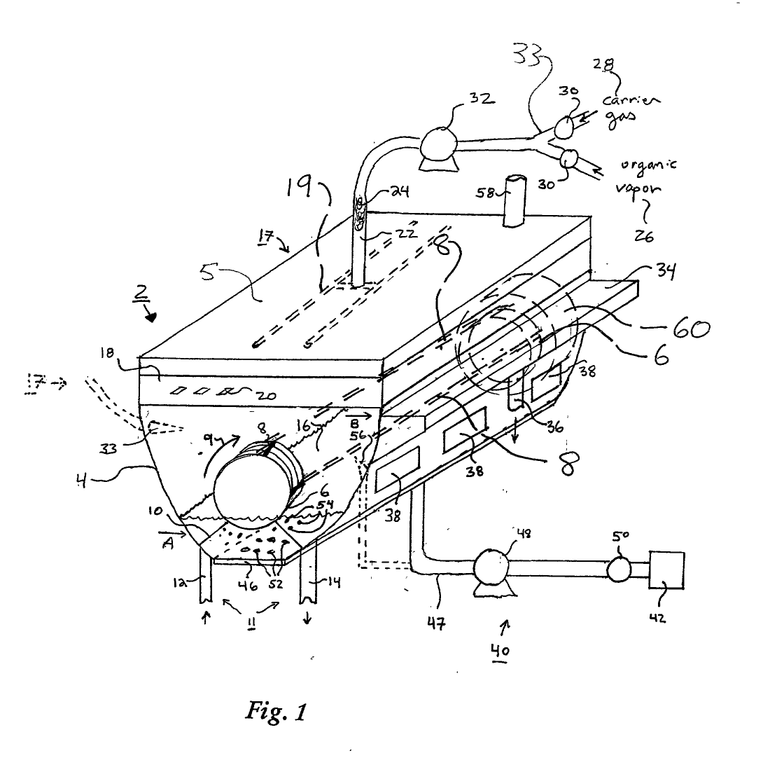

Referring now to the FIG. 1, a processor 2 includes a process vessel or tank 4. The processor 2 is used as a cleaner, rinser, and dryer for the processing of microelectronic workpieces 6, including, for example, semiconductor substrates. The processor 2 is adapted to clean, rinse, and dry one or more workpieces 6. Preferably, a batch of workpieces 6 are held within a cassette or holder 8 positioned within the process vessel 4. The cassette 8 preferably contacts each workpiece 6 with a minimum number of contact locations.

In a preferred embodiment, the cassette 8 and the one or more workpieces 6 are held stationary within the process vessel 4 during the cleaning, rinsing, and drying process. The cassette 8, however, may also be raised and lowered within the process vessel 4 during processing using known techniques. For stationary processing, the cassette or holder 8 may be held in place by a rack 10 located inside of the process vessel 4. The processor 2 can also employ a motor 60 to spin the cassette or holder 8, to provide more uniform processing. The spinning of the workpiece 6 is shown by the arrow 9 in FIG. 1. The workpieces are loaded and unloaded into the vessel 4 by opening or removing the vessel lid 5. The lid 5 can, but need not, seal the vessel. Rather, the lid 5 helps to contain and control the vapor phase processing.

The process vessel 4 includes a liquid supply or injection system 11 that introduces, extracts, and replenishes processing fluid 16 within the process vessel 4. The liquid injection system 11 includes one or more inlets 12, and one or more outlets 14, in the process vessel 4 for supplying and removing a processing fluid 16. Preferably, the processing fluid is deionized (DI) water. The level of processing fluid 16 within the process vessel 4 may be controlled by varying the flow rates through the inlet 12 and outlet 14. The flow rates are preferably controlled by a microprocessor-based controller.

The processor 2 also includes a drying system 17 connecting into the process vessel 4. The drying system 17 operates by delivering a drying fluid such as a drying gas 24 into the process vessel. The drying system 17 may include a gas diffuser 18 located at the top of the process vessel 4. The gas diffuser 18 advantageously includes a plurality of holes 20 to permit gas flow from above and into the vessel 4. While rectangular-shaped orifices 20 are shown in FIG. 1, other shapes can also be used. One or more gas delivery pipes 22 are preferably connected to the gas diffuser 18 (if used) to supply a drying gas 24 to the process vessel 4. The drying gas 24 may include any number of gases or gas mixtures. For example, the drying gas 24 might include N₂, air, N₂/air mixture, or an organic vapor 26 mixed with a carrier gas 28.

FIG. 1 illustrates the gas delivery pipe 22 connected to separate sources for the organic vapor 26 and the carrier gas 28, to provide surface tension effects for drying the workpieces 6. The organic vapor 26 is preferably isopropyl alcohol (IPA). Of course, materials other than IPA may be used to promote drying. The carrier gas 28 is preferably N₂, but other inert gases or even air can be used. The dilution of the combined organic vapor 26 and carrier gas 28 is preferably controlled by pressure regulators 30. The combined gas stream is preferably pumped into the process vessel by pump 32. A manifold 19 having spray nozzles may be used instead of the diffuser 18.

If a single gas component is used for the drying gas 24, the branch structure 33 shown in FIG. 1 is not necessary. The drying gas 24 is preferably directly pumped into the process vessel 4. As an alternative to introducing the drying gas to the process vessel 4 via a gas diffuser 18 or the top manifold 19, the drying fluid can be directly injected through one or more side nozzles 33 at the sides of the process vessel 4. The drying fluid can be injected or sprayed as either a liquid or a gas depending on the drying fluid used. Various other drying systems, with or without IPA or other chemicals, may be used, including drying systems using heat, air or gas movement, mechanical liquid removal, or other techniques.

An overflow weir or wall 34 may be provided in the vessel, e.g., located on one side of the process vessel 4. When the process fluid 16 rises to the level of the overflow weir 34, the process fluid 16 passes over the overflow weir 34 and into a drain 36. The overflow weir 34 ensures that the process vessel 4 does not overflow. In addition, the overflow weir 34 also serves as another outlet to remove processing fluid 16 that contains contaminants from the cleaning of the workpiece 6. The overflow weir 34, if used, can be located on any side of the process vessel 4.

One or more heaters 38 are preferably, but not necessarily, provided and located on the side of the process vessel 4. The heaters 38 are preferably located at a position that permits heat to be transferred from the heaters 38 to the processing fluid 16. The heaters 38, if used, may be positioned inside, within, or outside of the process vessel 4. The heaters 38 are preferably controlled by a microprocessor-based controller to control the temperature of the processing fluid 16 within the process vessel 4.

An ozone supply system 40 may be included for use in the vapor phase processing. If used, the ozone supply system 40 preferably includes a gas bubbler 46 connected via piping 47 to an ozone generator 42. A pump 48 may be used to pump the ozone gas from the ozone generator 42 into the process vessel 4. A flow control valve may also be used to control the flow of ozone gas into the process vessel 4. A gas regulator 50 is preferably located upstream of the pump 48. The ozone gas is preferably introduced into the process vessel 4 using the gas bubbler 46. The gas bubbler 46 includes openings 52 that create bubbles 54 of ozone gas within the processing fluid 16. As an alternative to the gas bubbler 46, one or more ozone spray nozzles or even simple ports 56 can be positioned within the process vessel 4 to provide ozone gas directly into the process vessel 4.

The process vessel 4 also preferably includes a gas vent 58 that permits the evacuation of gas from the process vessel 4. The gas vent 58 is located on the top of the processor 2 or on the lid 5.

In a preferred method, a cassette 8 containing a batch of workpieces is loaded into the processor 2. Loading may be performed by opening or removing the lid 5, and placing the cassette 8 onto a rack 10 within the process vessel 4. The cassette 8 can also be loaded into the process vessel 4 via a robot. During the cleaning phase of the process, a processing fluid 16 such as DI water is introduced into the process vessel 4 via inlet 12. The DI water level rises up from the bottom along the walls of the process vessel 4. The level of the processing fluid 16 is raised to a first level shown by arrow A in FIG. 1. This first level is preferably below the bottom edge of the workpieces 6 held within the cassette 8, so that the processing fluid 16 preferably does not contact the workpieces 6.

Next, the heaters 38 are preferably used to heat the processing fluid 16 within the process vessel 4. The processing fluid 16 is preferably heated to enhance the cleaning effect of the ozone gas on the workpiece 6. Of course, the processing fluid 16 can also be heated before or while the processing fluid 16 is introduced into the process vessel 4 by the drying system. Once the appropriate temperature of the processing fluid 16 has been established, the ozone injection system 40 begins to inject ozone gas into the process vessel 4. If used, the gas bubbler 46 bubbles ozone gas through the preferably heated processing fluid 16. The ozone gas becomes heated and moist, thereby enhancing the cleaning effects of the ozone gas on the workpieces 6. The ozone gas, if used, may alternatively be injected directly into the process vessel 4 via one or more nozzles 56. The ozone gas is introduced into the process vessel 4 for a period of time sufficient to strip or remove any remaining photoresist or other contaminants from the workpieces 6. Processing may also be performed at room temperature, without any heating, although heating is preferred.

After the vapor-phase cleaning step, the liquid-phase rinsing begins. Rinsing is important because the vapor phase cleaning step may not completely remove all contaminants. The level of the processing fluid 16 within the process vessel 4 is gradually increased to completely immerse the workpieces 6. The processing fluid 16 stops rising when it reaches the top of the overflow weir 34. This level is shown by arrow B in FIG. 1. At this point, the processing fluid 16 is preferably continuously refreshed to supply clean processing fluid 16 to the process vessel 4. Processing fluid 16 containing contaminants passes out of the process vessel 4 via the overflow weir 34 and drain 36, and optionally, the outlet 14.

The processing fluid 16 used in this rinsing step is preferably, but not necessarily, the same fluid or the same type of fluid as used in the preceding cleaning step. This immersion step may also not necessarily be a rinsing step. Rather, if a process chemical liquid is provided into the vessel, this step may be a process step which chemically processes the workpieces. A rinsing step (using a rinsing liquid such as water) may then be subsequently performed, preferably in the vessel, but potentially also in another vessel.

After rinsing the workpiece, the drying step begins with the gradual reduction of the level of processing fluid 16 within the process vessel 4 via the outlet 14. A drying gas 24 is preferably introduced into the process vessel 4 by the drying system 17. The drying gas 24 may be introduced via the gas diffuser 18 located at the top of the process vessel 4. If a liquid is used as the drying fluid, the liquid may be injected via injectors 33. The drying gas 24 may alternatively be introduced via injectors 33 in the process vessel 4. If surface tension effects are used, the drying gas 24 preferably includes an organic vapor component such as IPA to increase surface tension effect drying of the workpiece 6.

At the end of the cleaning/rinsing/drying process, when the processing fluid 16 has been removed from the process vessel 4, the workpieces 6 are removed from the processor 2. While DI water has been described as the preferred processing fluid, other processing fluids 16 can also be used. In addition, multiple processing fluids 16 can be introduced into the process vessel 4 in a continuous or near-continuous manner. This allows different processing fluids 16 to replace each other. The processing fluid 16 inside the process vessel 4 is removed from the process vessel 4 either by the overflow weir 34 or the outlet 14. The removed processing fluid 16 can then be returned to a process tank for recovery and reuse. Alternatively, the processing fluid 16 can be directed to a waste drain.

In another aspect of the invention a processor 2 of the type disclosed in pending U.S. patent application Ser. No. 09/590,724, filed Jun. 8, 2000, is used. This Application is incorporated by reference as if set forth fully herein. U.S. patent application Ser. No. 09/950,724 discloses a processor 2 that uses an outer containment vessel and a porous process vessel 4 to enhance drying.

While embodiments of the present invention have been shown and described, various modifications may be made without departing from the scope of the invention. The invention, therefore, should not be limited, except to the following claims, and their equivalents.

What is claimed:

1. A processor for cleaning, rinsing, and drying workpiece comprising:
a process vessel adapted to hold one or more workpieces therein;
a vapor processing system for supplying a vapor into the process vessel, for processing the workpieces;
a liquid supply system for introducing a liquid into the process vessel to rinse the workpieces by immersing the workpieces in the liquid; and
a drying system supplying a drying fluid into the process vessel, for drying the workpieces.

2. The processor according to claim 1 further including an ozone supply system connecting to the process vessel.

3. The processor according to claim 1 further including an overflow weir at one side of the process vessel.

4. The processor according to claim 2, wherein the ozone supply system comprises one or more spray nozzles within the process vessel.

5. The processor according to claim 2, wherein the ozone supply system comprises a gas bubbler located near the bottom.

6. The processor according to claim 1, wherein the drying system includes a gas diffuser at the top of the process vessel.

7. The processor according to claim 1, further comprising one or more heaters in or on the process vessel for heating liquid in the process vessel.

8. The processor according to claim 1, further including a rack in the process vessel for holding the one or more workpieces stationary within the process vessel during the cleaning, rinsing, and drying steps.

9. The processor according to claim 1, further comprising a motor associated with the process vessel for spinning the one or more workpieces.

10. The processor according to claim 1, wherein the drying system comprises one or more injectors inside the process vessel.

11. A processor for cleaning, rinsing, and drying workpieces comprising:
a process vessel adapted to hold one or more workpieces therein;
an ozone injection system coupled to the process vessel for introducing ozone gas into the process vessel by bubbling the ozone gas up through a liquid in the process vessel;
a liquid injection system coupled to the process vessel for introducing a processing fluid into the process vessel; and
a drying system coupled to the process vessel for supplying a drying gas into the process vessel.

12. The processor according to claim 11, wherein the drying system comprises a gas diffuser at the top of the process vessel.

13. The processor according to claim 11, further comprising one or more heaters on the process vessel.

14. The processor according to claim 11, further comprising a spinning mechanism for spinning the one or more workpieces within the process vessel.

15. The processor according to claim 11, further comprising a rack in the process vessel for holding the one or more workpieces.

16. The processor according to claim 11, wherein the drying system comprises one or more gas spray nozzles inside the process vessel.

17. A method for cleaning, rinsing, and drying one or more workpieces within a single process vessel, comprising the steps of:
placing the workpieces into the process vessel;
introducing a processing fluid into the process vessel, with the processing fluid beneath the workpiece;
introducing ozone gas into the process vessel;
immersing the workpieces in the processing fluid within the process vessel;
introducing a drying fluid into the process vessel; and
removing the processing fluid from the process vessel.

18. The method of claim 17, further comprising the step of heating the processing fluid before introducing the ozone gas into the process vessel.

19. The method of claim 17, wherein the step of introducing the ozone gas comprises by bubbling ozone into the process fluid.

20. The method of claim 17, further comprising the step of continuously introducing processing fluid into the process vessel during the immersing.

21. The method of claim 17, wherein the step of introducing a drying gas comprises the step of introducing a dilute organic vapor above the processing fluid in the process vessel.

22. The method of claim 21, wherein the dilute organic vapor comprises isopropyl alcohol.

23. The method of claim 17, wherein the drying fluid is a drying gas selected from the group consisting of air and nitrogen.
